(19) United States
(12) Patent Application Publication
(10) Pub. No.: US 2026/0008657 A1
(43) Pub. Date: Jan. 8, 2026

(54) INDUSTRIAL TRUCK COMPRISING A HYDRAULIC SYSTEM AND AT LEAST ONE HYDRAULICALLY OPERATED COMPONENT, AND METHOD FOR OPERATING A HYDRAULIC SYSTEM OF AN INDUSTRIAL TRUCK

(71) Applicant: Jungheinrich AG, Hamburg (DE)

(72) Inventors: Thomas STOLTEN, Tremsbuettel (DE); Tim PAGELS, Wakendorf (DE)

(73) Assignee: Jungheinrich AG, Hamburg (DE)

(21) Appl. No.: 19/257,072

(22) Filed: Jul. 1, 2025

(30) Foreign Application Priority Data
Jul. 4, 2024 (DE) 10 2024 119 072.8

(51) Int. Cl. B66F 9/22

(52) U.S. Cl. CPC B66F 9/22

(57) ABSTRACT

An industrial truck including a hydraulic system and at least one hydraulically operated component. The hydraulic system includes a first hydraulic pump, a second hydraulic pump, and a hydraulic line system. The hydraulic line system is configured to selectively connect the hydraulically operated component either exclusively to the first hydraulic pump or exclusively to the second hydraulic pump or simultaneously to the first hydraulic pump and the second hydraulic pump. The first hydraulic pump has a first efficiency maximum at a first volume flow and a first operating pressure and the second hydraulic pump has a second efficiency maximum at a second volume flow and a second operating pressure, and one or more of the first operating pressure is greater than the second operating pressure and the first volume flow is smaller than the second volume flow.

### CROSS-REFERENCE TO RELATED APPLICATION

The present application is based upon and claims the benefit of priority from DE 10 2024 119 072.8 filed on Jul. 4, 2024, the entire contents of which is incorporated herein by reference.

### BACKGROUND

### Field

The present disclosure relates to an industrial truck comprising a hydraulic system and at least one hydraulically operated component. The present disclosure also relates to a method for operating a hydraulic system of an industrial truck.

### Prior Art

Industrial trucks are often equipped with a hydraulic system to operate various hydraulically driven components. A classic example is the load forks of a forklift truck, which are raised and lowered hydraulically. However, there are also a number of other adjustment functions that are executed by hydraulically operated components. These include, for example, tilting the load fork, tilting the mast, sideshifting the load fork or, in the case of reach trucks or similar industrial trucks, mast advance. In addition, attachments with hydraulically operated components are often used in industrial trucks.

A key aspect in the design of the hydraulic system is the selection of a suitable hydraulic pump to drive the hydraulically operated components. External gear pumps and internal gear pumps, for example, are used as hydraulic pumps for industrial trucks. Axial piston pumps, radial piston pumps and vane pumps can also be used as hydraulic pumps for industrial trucks. The individual types of pumps differ in that they achieve high efficiency at different speeds and operating pressures and in different temperature ranges. The noise emissions of hydraulic pumps also differ from one another, also depending on the required operating pressures and speeds.

If the hydraulic system only operates a single hydraulically operated component with a single adjustment function, then the appropriate hydraulic pump can be selected based on the pump speed and operating pressure required for this adjustment function in order to optimize efficiency and noise emissions. However, if the industrial truck is designed to execute a plurality of different adjustment functions, the hydraulic pump cannot execute all adjustment functions with optimal efficiency.

### SUMMARY

An object can be to improve the efficiency and noise emission of a hydraulic system of an industrial truck with a plurality of hydraulic adjustment functions.

Such object can be achieved by an industrial truck comprising a hydraulic system and at least one hydraulically operated component, wherein the hydraulic system has a first hydraulic pump, a second hydraulic pump and a hydraulic line system, wherein the hydraulic line system is configured to selectively connect the hydraulically operated component either exclusively to the first hydraulic pump or exclusively to the second hydraulic pump or simultaneously to the first hydraulic pump and the second hydraulic pump, wherein the first hydraulic pump has a first efficiency maximum at a first volume flow and a first operating pressure and the second hydraulic pump has a second efficiency maximum at a second volume flow and a second operating pressure, wherein one or more of the first operating pressure is greater than the second operating pressure and the first volume flow is smaller than the second volume flow.

The efficiency and noise emission of the hydraulic system can be improved by using two different hydraulic pumps by selecting the appropriate hydraulic pump for each adjustment function. For example, the first hydraulic pump can be selected so that it reaches its efficiency maximum at a first volume flow that is smaller than the second volume flow at which the second hydraulic pump has its efficiency maximum. The volume flow is the volume flow of the hydraulic fluid that drives the hydraulically operated component. The first efficiency maximum is the efficiency maximum of the first hydraulic pump and the second efficiency maximum is the efficiency maximum of the second hydraulic pump. In addition, the first operating pressure at which the first hydraulic pump reaches its basic efficiency maximum can be greater than the second operating pressure at which the second hydraulic pump reaches its efficiency maximum. In this way, based on the required operating pressures and the required volume flows of the adjustment function, it is possible to select which of the hydraulic pumps or combination of hydraulic pumps is better suited to execute this adjustment function.

The volume flow required for an adjustment function can be achieved by selecting a pump speed of the hydraulic pumps accordingly. The pump speed required to achieve a certain volume flow can be calculated by dividing the volume flow by the known displacement volume. The displacement volume is the displaced volume of all displacement elements of the hydraulic pump during one revolution. The displacement volumes of the first hydraulic pump and the second hydraulic pump do not have to be necessarily identical. If the displacement volumes of the two hydraulic pumps differ, the two pumps can require different pump speeds to achieve the same volume flow. The volume flow at which a hydraulic pump reaches its efficiency maximum can therefore be dependent on the pump speed at which this efficiency maximum is reached. When multiple hydraulic pumps are used simultaneously, the volume flow generated by the hydraulic pumps can add up.

The at least one hydraulically operated component can comprise at least one hydraulically operated cylinder and/or one hydraulically operated motor. The at least one hydraulically operated component can comprise all hydraulically operated components of the industrial truck. The first hydraulic pump can be a pump optimized for a high operating pressure. The second hydraulic pump can be a noise-optimized pump and/or a pump optimized for a high pump speed or a high-volume flow. Noise-optimized pumps can have their efficiency maximum at a high pump speed or a high-volume flow, and at a comparatively low operating pressure.

According to one embodiment, the first hydraulic pump can be an internal gear pump and/or the second hydraulic pump can be an external gear pump. These pump types differ in that they achieve their efficiency maximum in different flow and pressure ranges, depending on the temperature at which they operate. Internal gear pumps still have good efficiency at high operating pressures and low pump speeds or volume flows over a wide temperature range compared to external gear pumps. External gear pumps, on the other hand, have the advantage of often operating much more quietly than internal gear pumps and of having good efficiency in operating ranges of medium to high speeds or volume flows. By providing these two types of hydraulic pumps in the hydraulic system, the hydraulic system can be optimized in terms of efficiency and noise emission according to the requirements of the particular hydraulic adjustment function. An axial piston pump, a radial piston pump or a vane pump can also be used as the first hydraulic pump and/or second hydraulic pump. The two pumps can differ in that they achieve their efficiency maximum at a different operating pressure and/or a different pump speed.

The hydraulic line system can comprise at least one hydraulic valve, wherein the at least one hydraulic valve can have a first position, a second position and a third position, wherein in the first position the at least one hydraulically operated component can be connected exclusively to the first hydraulic pump, wherein in the second position the at least one hydraulically operated component can be connected exclusively to the second hydraulic pump, wherein in the third position the at least one hydraulically operated component can be connected simultaneously to the first hydraulic pump and the second hydraulic pump. By selecting the first position, the second position or the third position, the at least one hydraulically operated component can thus be operated exclusively by the first hydraulic pump or exclusively by the second hydraulic pump or simultaneously by the first hydraulic pump and the second hydraulic pump. Consequently, the at least one hydraulic valve can allow the hydraulically operated component to be operated with the appropriate hydraulic pump for the adjustment function currently being executed. To select between the first position, the second position and the third position, either a single hydraulic valve or a plurality of hydraulic valves can be switched. For example, a single hydraulic valve can be provided which, for a particular hydraulically operated component, selectively connects that component to the first hydraulic pump, the second hydraulic pump, or both hydraulic pumps. It can also be provided that a first hydraulic valve opens or blocks a connection between the component and the first hydraulic pump and a second hydraulic valve opens or blocks a connection between the component and the second hydraulic pump, and in this way the three positions are realized. The at least one hydraulic valve can have a fourth position in which the hydraulically operated component is not driven by a hydraulic pump.

The at least one hydraulically operated component is configured to execute at least two different hydraulically driven adjustment functions which differ with regard to a required pump speed and/or a required volume flow. The hydraulically driven adjustment functions can include all hydraulic adjustment functions of the industrial truck. It can include various mast lifting functions with different speeds and/or an inclination of the load-carrying means and/or an inclination of the mast and/or an advance of the mast and/or similar adjustment functions. The at least one hydraulically operated component can comprise at least two different hydraulically operated components. For example, the industrial truck can comprise a lifting cylinder for raising and lowering the load-carrying means (e.g., load fork) and another hydraulic cylinder or hydraulically operated motor, e.g. for inclining the load-carrying means. The at least two different adjustment functions can be executed by a single hydraulically operated component or by a plurality of different hydraulically operated components. The first position, the second position and the third position of the at least one hydraulic valve can be adjusted separately for each hydraulically operated component. In other words, for each hydraulically operated component it can be selected separately whether it is connected exclusively to the first hydraulic pump or exclusively to the second hydraulic pump or simultaneously to the first hydraulic pump and the second hydraulic pump.

According to one embodiment, the industrial truck can comprise a control device (controller, processor, CPU, computer, circuit etc.), wherein the control device can be configured to access a data memory on which a function list is stored, in which the required operating pressure and the required volume flow are stored for the at least two different adjustment functions, wherein, for an adjustment function to be executed, the control device can be further configured to retrieve the operating pressure required for this adjustment function and the volume flow required for this adjustment function from the function list and to control the at least one hydraulic valve in order to transfer the at least one hydraulic valve into the first position or the second position or the third position, depending on the operating pressure required for this adjustment function and the volume flow required for this adjustment function. The control device can be configured to select a suitable hydraulic pump or suitable hydraulic pumps for an adjustment function to be executed in order to optimize the efficiency and noise emission depending on the application.

The pump speed influences the volume flow. The higher the pump speed, the higher the volume flow. With a higher volume flow, for example, a hydraulic cylinder is deflected more quickly. The pump speed or volume flow therefore affects how quickly, for example, the load-carrying means is raised or lowered. The operating pressure influences the force exerted by the hydraulically operated component. The higher the operating pressure, the greater the force exerted. Certain adjustment functions, such as the lift of the load-carrying means, require a significantly higher operating pressure than other adjustment functions, such as a mast advance on a reach truck.

For each adjustment function the function list contains an optimal temperature range for the hydraulic fluid. The control device can be configured to also take into account the temperature of the hydraulic fluid of the adjustment function to be executed when controlling the hydraulic valve and to compare this with a measured current temperature of the hydraulic fluid.

The control device can be a controller of the industrial truck. For example, the control device is a computer or similar data processing device which is configured to control the various functions of the industrial truck. The data memory can be a component of the control device or can be connected to the control device. Alternatively, the data memory can be configured separately from the control device and separately from the industrial truck. For example, the data memory can be an external data memory in a goods logistics facility and the control device can be configured to access the data memory wirelessly.

The adjustment function to be executed can be one of at least two different hydraulically driven adjustment functions that are currently being executed or are to be executed. For example, a truck driver operates a control element to cause the truck's load-carrying means to be raised at high speed. The control device can then access the data memory to retrieve the required volume flow and the required operating pressure and, a temperature range for this adjustment function that is to be executed. Subsequently, depending on the required volume flow and the required operating pressure and the operating temperature, the control device can select either the first position or the second position or the third position in order to control the at least one hydraulic valve in such a way that the hydraulically operated component which carries out the adjustment function to be executed is driven by the appropriate hydraulic pump or the appropriate combination of hydraulic pumps.

The control device can be configured to compare the operating pressure required for the adjustment function to be executed with a limit pressure in order to select the position to which the at least one hydraulic valve is transferred. In other words, in order to select the appropriate hydraulic pump or combination of hydraulic pumps, the required operating pressure can be compared with a limit pressure. If the required operating pressure is for example, lower than the limit pressure, then the at least one hydraulic valve can be moved for example, to the second position in order to drive the at least one hydraulically operated component exclusively with the second hydraulic pump. Otherwise, the at least one hydraulic valve can be moved to either the first position or the third position. In this way, the selection of the hydraulic pump or pumps can be made depending on the force requirement of the adjustment function to be executed.

The control device can be configured to compare the volume flow required for the adjustment function to be executed with a first limit volume flow and a second limit volume flow in order to select the position to which the at least one hydraulic valve is transferred. The second limit volume flow can be greater than the first limit volume flow. By comparing the required volume flow with the first limit volume flow and the second limit rotary volume flow, the appropriate hydraulic pump or combination of hydraulic pumps can be selected depending on the required volume flow of the adjustment function to be executed. For example, if the required volume flow is very small, the first hydraulic pump can be selected; if the required volume flow is medium, the second hydraulic pump can be selected; and if the required volume flow is very high, a combination of both hydraulic pumps can be selected. In this way, for example when lifting the load-carrying means at different speeds, a different hydraulic pump or combination of hydraulic pumps can be selected to operate the lifting cylinder.

The control device can be configured to allow the at least one hydraulically operated component to be operated exclusively by the first hydraulic pump, provided that the required operating pressure is greater than the limit pressure and the required volume flow is less than the first limit volume flow. If the required operating pressure is greater than the limit pressure and the required volume flow is less than the first limit volume flow, the control device can transfer the at least one hydraulic valve to the first position so that only the first hydraulic pump operates the hydraulically operated component. This is useful, for example, in order to optimize efficiency when lifting the load-carrying means slowly, when tilting the load-carrying means, when inclining the mast, or when the load-carrying means is shifted sideways.

The control device can be configured to have the at least one hydraulically operated component operated exclusively by the second hydraulic pump, provided that the required operating pressure is less than the limit pressure or the required volume flow is greater than the first limit volume flow and less than the second limit volume flow. In this case, at least one hydraulic valve can be moved to the second position. This is useful for example when lifting the load-carrying means at a medium speed, since in this case a medium to high pump speed is required, even if the operating pressure is comparatively high. In the case of a mast advance, as realized for example with reach trucks, the second position can also be useful, since here only a low operating pressure is necessary and a medium pump speed or medium volume flow is usually used.

The control device can be configured to allow the at least one hydraulically operated component to be operated simultaneously by the first hydraulic pump and the second hydraulic pump, provided that the required volume flow is greater than the second limit volume flow. In this case, at least one hydraulic valve can be moved to the third position. This can be useful, for example, when lifting the load-carrying means quickly, as this requires a very high pump speed or a very high volume flow and also a high operating pressure. When operating the at least one hydraulically operated component with both hydraulic pumps, the operating pressure can be higher than the limit pressure. At a lower operating pressure, the second hydraulic pump can be used by itself.

In cases where the operating pressure exactly corresponds to the limit pressure, the case in which an operating pressure is lower than the limit pressure or the case in which an operating pressure is higher than the limit pressure can be selected depending on preference. This also applies to the volume flow compared to the first limit volume flow and compared to the second limit volume flow. In an intermediate range of the volume flow, where both hydraulic pumps could run with a similarly good efficiency, such as the hydraulic pump with the lower noise level is used.

According to one embodiment, the at least one hydraulically operated component can comprise at least one hydraulic lifting cylinder for raising and/or lowering a load-carrying means of the industrial truck, wherein the control device can be configured to have the at least one lifting cylinder operated exclusively by the first hydraulic pump or exclusively by the second hydraulic pump or simultaneously by the first hydraulic pump and the second hydraulic pump, depending on a deflection speed of the lifting cylinder. The load-carrying means can be, for example, a load fork or a transport platform of the industrial truck. Since the control device can be configured to move the hydraulic valve either to the first position, the second position or the third position depending on the deflection speed, the lifting cylinder can always be driven with good efficiency and no unnecessary noise emissions are generated.

According to a further embodiment, the at least one hydraulically operated component can comprise an auxiliary component, wherein the control device can be configured to have the auxiliary component operated exclusively by the second hydraulic pump. The auxiliary component executes an auxiliary function and can be different from the hydraulic cylinder for lifting and/or lowering the load-carrying means. The auxiliary component can comprise for example a hydraulic motor or a hydraulic cylinder, which is provided for example for inclining the load-carrying means or for mast advance in a reach truck. The auxiliary component can execute at least one adjustment function which can require a lower operating pressure than the lifting cylinder for raising and/or lowering the load-carrying means. The auxiliary components can be driven by the second hydraulic pump.

According to one embodiment, the control device can be configured to regulate an efficiency portion of the first hydraulic pump and/or the second hydraulic pump when the first hydraulic pump and the second hydraulic pump are operated simultaneously, wherein the efficiency portion can be regulated by reducing a pump output and/or a flow rate. By regulating the efficiency portions, a pump output and/or a flow rate can be reduced in order to improve the efficiency of the two hydraulic pumps operating simultaneously. The efficiency portion is the portion of the force exerted by the hydraulically operated component that is attributable to the respective hydraulic pump. If the at least one hydraulic valve is in the third position, both hydraulic pumps can drive the at least one hydraulically operated component simultaneously. In this case, one or both of these hydraulic pumps do not have to operate at full power in order to improve efficiency and/or noise emissions. In other words, the hydraulic pumps can be operated optimally with different efficiency portions according to their efficiency. The function list for at least one adjustment function can comprise a reduced efficiency portion of the first hydraulic pump and/or the second hydraulic pump. The control device can be configured to access the function list and to control the first hydraulic pump and/or the second hydraulic pump in order to reduce the output of the hydraulic pumps in accordance with the stored efficiency portions.

Such object can be further achieved by a method for operating a hydraulic system of an industrial truck, wherein the hydraulic system comprises a first hydraulic pump, a second hydraulic pump and a hydraulic line system, wherein the hydraulic line system selectively connects at least one hydraulically operated component either exclusively to the first hydraulic pump or exclusively to the second hydraulic pump or simultaneously to the first hydraulic pump and the second hydraulic pump, wherein the first hydraulic pump has a first efficiency maximum at a first volume flow and a first operating pressure and the second hydraulic pump has a second efficiency maximum at a second volume flow and a second operating pressure, wherein one or more of the first operating pressure is greater than the second operating pressure and the first volume flow is less than the second volume flow.

The method for operating a hydraulic system of an industrial truck can embody the same advantages, features and characteristics as the industrial truck described above.

The hydraulic line system can comprise at least one hydraulic valve, wherein the at least one hydraulic valve can be selectively set to a first position, a second position or a third position, wherein in the first position the at least one hydraulically operated component can be connected exclusively to the first hydraulic pump, wherein in the second position the at least one hydraulically operated component can be connected exclusively to the second hydraulic pump, wherein in the third position the at least one hydraulically operated component can be connected simultaneously to the first hydraulic pump and the second hydraulic pump.

The at least one hydraulically operated component can execute at least two different adjustment functions which differ with regard to a required volume flow and/or a required operating pressure.

A control device of the industrial truck can access a data memory on which a function list is stored, in which the required operating pressure and the required volume flow for the at least two different adjustment functions can be stored, wherein, for an adjustment function to be executed, the control device can retrieve the operating pressure required for this adjustment function and the volume flow required for this adjustment function from the function list and controls the at least one hydraulic valve in order to transfer the at least one hydraulic valve into the first position or the second position or the third position depending on the operating pressure required for this adjustment function and the volume flow required for this adjustment function.

The control device can regulate an efficiency portion of the first hydraulic pump and/or the second hydraulic pump when the first hydraulic pump and the second hydraulic pump are operated simultaneously, wherein the efficiency portion can be regulated by reducing a pump output and/or a flow rate.

### BRIEF DESCRIPTION OF THE DRAWINGS

Further features will become apparent from the description of embodiments together with the claims and the accompanying drawings. Embodiments can implement individual features or a combination of several features.

The embodiments are described below without limiting the general inventive idea on the basis of exemplary embodiments with reference to the drawings, wherein reference is expressly made to the drawings with respect to all details which are not explained in more detail in the text. In the drawings:

FIG. 1 illustrates a simplified schematic perspective view of an industrial truck in the form of a reach truck,

FIG. 2 illustrates a simplified schematic representation of a hydraulic system of an industrial truck,

FIG. 3 illustrates a simplified schematic cross-sectional view of an internal gear pump,

FIG. 4 illustrates a simplified schematic cross-sectional view of an external gear pump, and

FIG. 5 illustrates a simplified schematic flow diagram of a method for operating a hydraulic system of an industrial truck with two different hydraulic pumps.

In the drawings, elements and/or parts that are the same or of the same type are provided with the same reference numbers, so that they are not presented again in each case.

### DETAILED DESCRIPTION

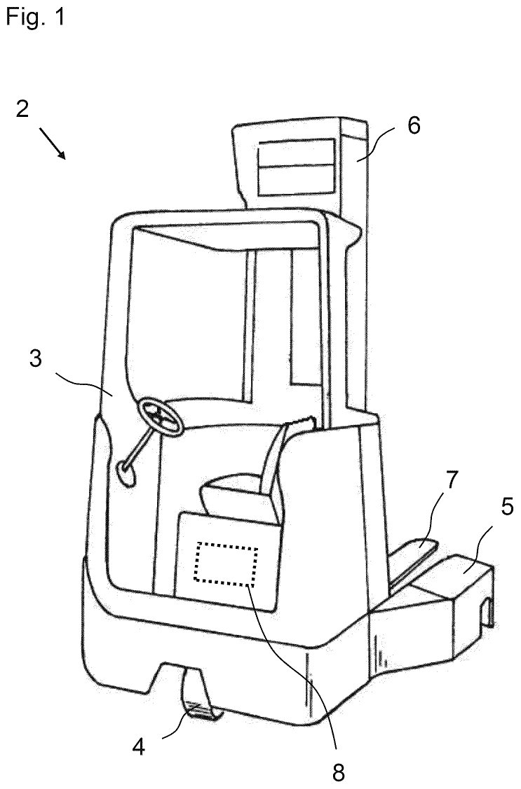

In FIG. 1, a simplified schematic perspective view of an industrial truck 2 in the form of a reach truck is shown. The industrial truck 2 comprises a driver's cab 3 and a plurality of wheels, of which only the drive wheel 4 is visible in FIG. 1. The reach truck comprises two wheel arms 5, of which only one is visible. A load-carrying means 7 in the form of a load fork is arranged on a mast 6 of the industrial truck 2 and can be raised and lowered by means of a lifting cylinder (not visible). In the case of a reach truck, it is also possible to move the mast 6 together with the load-carrying means 7 forwards and backwards in a horizontal direction between the wheel arms 5. The mast 6 and/or the load-carrying means 7 of an industrial truck 2 can also be inclined or moved laterally in various ways. To operate such adjustment functions, a hydraulic system is usually provided which is controlled by a control device 8 (e.g., controller, processor, CPU, circuit etc.). The control device 8 is shown in FIG. 1 with dashed lines because it is hidden inside the industrial truck 2.

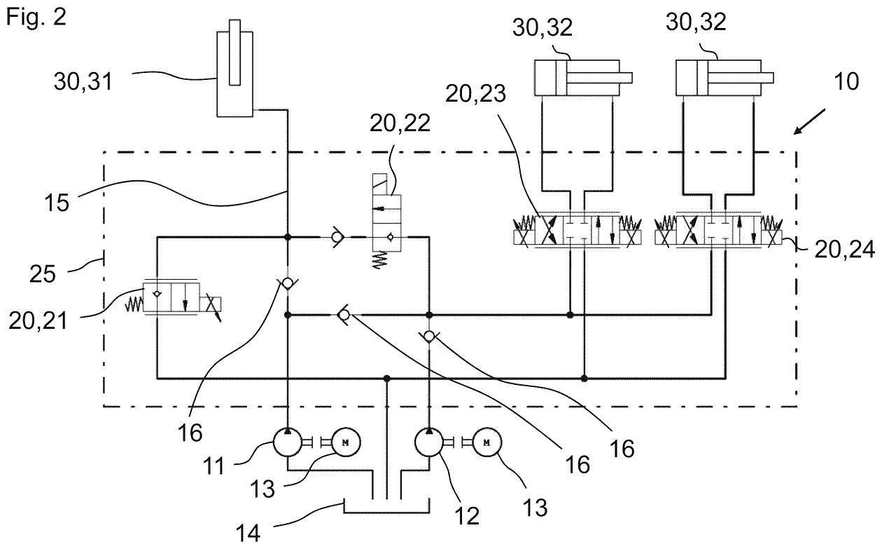

FIG. 2 shows a schematically simplified exemplary embodiment of a hydraulic system 10 as used for example in the industrial truck 2 of FIG. 1. The hydraulic system 10 is connected to a plurality of hydraulically operated components 30 which are driven by the hydraulic system 10. For this purpose, the hydraulic system 10 comprises a tank 14 with hydraulic fluid. A hydraulic line system 15 with a plurality of hydraulic lines connects the tank 14 to a first hydraulic pump 11 and a second hydraulic pump 12, each driven by a motor 13. The first hydraulic pump 11 differs from the second hydraulic pump 12 in that it has its maximum effect at a higher operating pressure and/or a lower pump speed than the second hydraulic pump 12. The hydraulic line system 15 connects the two hydraulic pumps 11, 12 with a switching system 25 which has a plurality of hydraulic valves 20. Specifically, the first hydraulic pump 11 and the second hydraulic pump 12 are connected to a 2/2 directional control valve 21, another 2/2 directional control valve 22 and two 4/3 directional control valves 23, 24 as well as a plurality of vent connections 16, which together form the hydraulic valves 20 of the hydraulic system. Through the 2/2 way valve 22, a lifting cylinder 31 is supplied with hydraulic fluid from the hydraulic pumps 11, 12, while the 2/2 way valve 21 returns the hydraulic fluid. The 2/2 way valves 21, 22 can each either open or close the line in one direction. In the embodiment shown, two auxiliary components 32 are each double-acting cylinders. One of the 4/3 way valves 23, 24 is provided in each case between the hydraulic pumps 11, 12 and the auxiliary components 32. The 4/3-way valves regulate the direction in which the hydraulic fluid flows into the double-acting cylinder and the direction from which the hydraulic fluid flows into a drain line, which in turn connects the auxiliary components 32 to the tank 14.

By switching the hydraulic valves 20, i.e. the valves 21, 22, 23, 24 and the vent connections 16, the hydraulic system 10 shown in FIG. 2 allows each of the hydraulically operated components 30 to be operated either exclusively with the first hydraulic pump 11, exclusively with the second hydraulic pump 12 or simultaneously with the first hydraulic pump 11 and the second hydraulic pump 12. Thus, by adjusting the hydraulic valves 20 accordingly, a first position (only the first hydraulic pump 11), a second position (only the second hydraulic pump 12) or a third position (both hydraulic pumps 11, 12 simultaneously) can be set for each of the components 30. In addition, a fourth position can be set for each hydraulically operated component 30, in which the hydraulically operated component 30 is not driven by any hydraulic pump 11, 12.

The hydraulic system 10 shown in FIG. 2 makes it possible to select an optimal hydraulic pump 11, 12 or combinations of hydraulic pumps 11, 12 for each adjustment function of the industrial truck 2 executed with the hydraulically operated components 30, so that the hydraulic pumps 11, 12 have a good efficiency and noise emissions are minimized. Likewise, it can be provided that the control device 8 accesses the hydraulic pumps 11, 12, and the motor 13 of the hydraulic pumps 11, 12, in order to reduce an efficiency portion of the hydraulic pumps 11, 12 when both hydraulic pumps 11, 12 are connected simultaneously to a specific hydraulically operated component 30. In this way, the efficiency of the hydraulic pumps 11, 12 can be further improved.

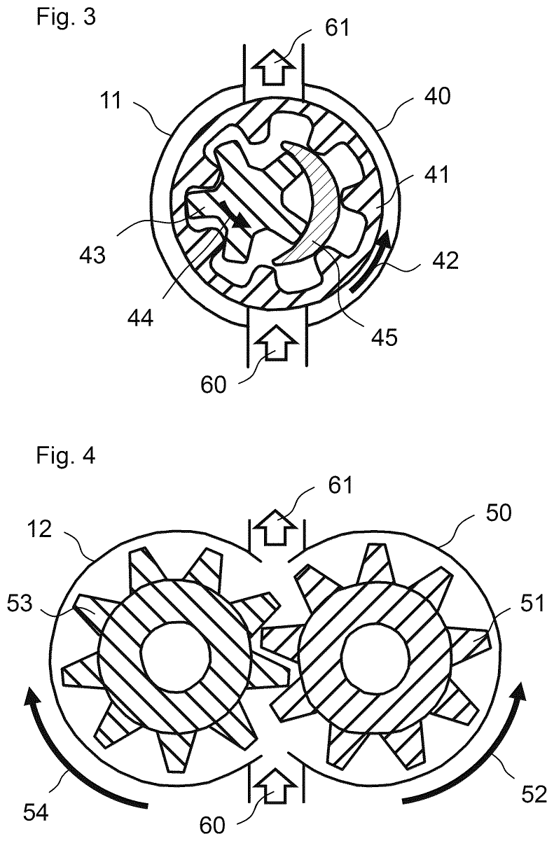

FIG. 3 shows a schematically simplified cross section of an exemplary embodiment of the first hydraulic pump 11. The hydraulic pump 11 shown in this example is an internal gear pump 40 in the form of a so-called sickle pump. The internal gear pump 40 has an outer toothed ring 41 with an internal toothing in which the teeth of an eccentrically arranged internal gear 43 engage. A sickle 45 is additionally arranged between the gear 43 and the toothed ring 41. The direction of rotation 42 of the toothed ring 41 is identical to the direction of rotation 44 of the gear 43. Hydraulic fluid enters the space between the toothed ring 41 and the gear wheel 43 from below in the inlet direction 60. The hydraulic fluid is conducted from bottom to top on two paths to the left and right of the sickle 45 and exits the internal gear pump 40 again in the outlet direction 61. Such internal gear pumps 40 have a high efficiency at high operating pressures and low pump speeds or volume flows even over a wide temperature range.

FIG. 4 shows a schematically simplified cross-sectional view of a second hydraulic pump 12 in the form of an external gear pump 50. The external gear pump 50 comprises a first gear 51 and a second gear 53, the teeth of which mesh with each other. The rotation direction 52 of the first gear 51 is opposite to the rotation direction 51 of the second gear 53. If hydraulic fluid enters the external gear pump 50 from below in the inlet direction 60, the hydraulic fluid is pumped by the two gears 51, 53 in each case along the outside of the gears 51, 53 in the direction of the rotational directions 52, 54 and finally exits the external gear pump 50 at the top in the direction of the outlet direction 61. Such external gear pumps 50 are often significantly quieter than internal gear pumps 40 and have a good efficiency at medium to high pump speeds or volume flows.

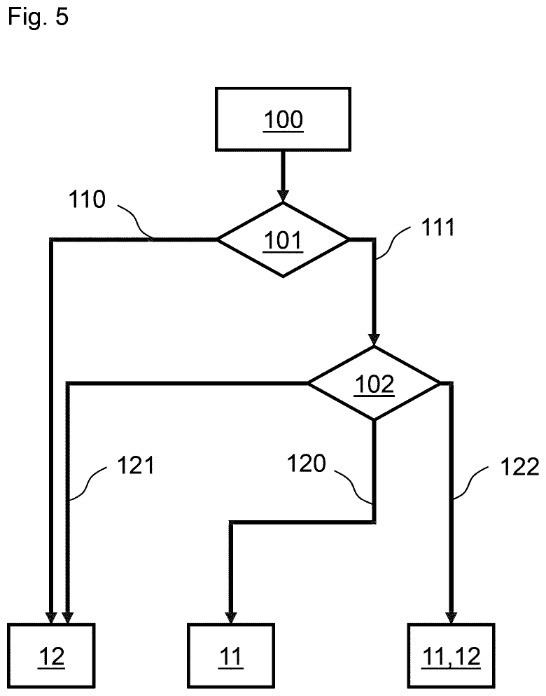

FIG. 5 shows a schematically simplified flow diagram of a method for operating a hydraulic system 10 of an industrial truck 2. First, an adjustment function 100 is selected that is to be executed. For example, the driver of the industrial truck 2 actuates a control element to execute the adjustment function 100. It is then checked whether an operating pressure 101 is less than or greater than a previously defined limit pressure. If the operating pressure 101 is lower than the limit pressure, i.e. a low pressure 110 is required for the adjustment function 100, the hydraulic valves 20 are moved to the second position, in which the hydraulically driven component 30 which executes the adjustment function 100 is connected exclusively to the second hydraulic pump 12. If the operating pressure 101 is greater than the limit pressure, i.e. if a high pressure 111 is present, it is then checked which volume flow 102 is required to execute the adjustment function 100. In the embodiment shown, a first limit volume flow and a larger, second limit volume flow are defined for the required volume flow 102. If volume flow 102 is smaller than the first limit volume flow, i.e. if there is a low volume flow 120, the hydraulically operated component 30 is operated exclusively by the first hydraulic pump 11. If the volume flow 102 is greater than the first limit volume flow but smaller than the second limit volume flow, i.e. there is a medium to high volume flow 121, the hydraulically operated component 30 is driven exclusively by the second hydraulic pump 12. At a very high volume flow 122, at which the volume flow 102 is greater than the second limit volume flow, the hydraulically operated component 30 is driven by both hydraulic pumps 11, 12. In this way, it is achieved that, depending on the required volume flow and the required operating pressure 101 of the adjustment function 100 to be executed, the hydraulic pump 11, 12 or combination of hydraulic pumps 11, 12 is selected with which an optimal efficiency and reduced noise emission is achieved.

While there has been shown and described what is considered to be embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

### LIST OF REFERENCE NUMBERS

2 Industrial truck
3 Driver's cab
4 Drive wheel
5 Wheel arm
6 Mast
7 Load fork
8 Control device
10 Hydraulic system
11 First hydraulic pump
12 Second hydraulic pump
13 Motor
14 Tank
15 Hydraulic line system
16 Vent connection
20 Hydraulic valve
21 2/2 way valve
22 2/2 way valve
23 4/3 way valve
24 4/3 way valve
25 Switching system
30 Hydraulically operated component
31 Lifting cylinder
32 Auxiliary component
40 Internal gear pump
41 Toothed ring
42 Direction of rotation
43 Gear
44 Direction of rotation
45 Sickle
50 External gear pump
51 First gear
52 Direction of rotation
53 Second gear
54 Direction of rotation
60 Inlet direction
61 Outlet direction
100 Adjustment function
101 Operating pressure
102 Volume flow
110 Low pressure
111 High pressure
120 Low volume flow
121 High volume flow
122 Very high volume flow

1. An industrial truck comprising:
a hydraulic system; and
at least one hydraulically operated component,
wherein the hydraulic system comprises:
a first hydraulic pump,
a second hydraulic pump, and
a hydraulic line system, wherein the hydraulic line system is configured to selectively connect the hydraulically operated component either exclusively to the first hydraulic pump or exclusively to the second hydraulic pump or simultaneously to the first hydraulic pump and the second hydraulic pump,
the first hydraulic pump has a first efficiency maximum at a first volume flow and a first operating pressure and the second hydraulic pump has a second efficiency maximum at a second volume flow and a second operating pressure, and
one or more of the first operating pressure is greater than the second operating pressure and the first volume flow is smaller than the second volume flow.

2. The industrial truck according to claim 1, wherein one or more of the first hydraulic pump is an internal gear pump and the second hydraulic pump is an external gear pump.

3. The industrial truck according to claim 1, wherein
the hydraulic line system comprises at least one hydraulic valve,
the at least one hydraulic valve has a first position, a second position and a third position,
in the first position the at least one hydraulically operated component is connected exclusively to the first hydraulic pump,
in the second position the at least one hydraulically operated component is connected exclusively to the second hydraulic pump, and
in the third position the at least one hydraulically operated component is connected simultaneously to the first hydraulic pump and the second hydraulic pump.

4. The industrial truck according to claim 1, wherein the at least one hydraulically operated component is configured to carry out at least two different hydraulically driven adjustment functions which differ with regard to one or more of a required volume flow and a required operating pressure.

5. The industrial truck according to claim 4, further comprising a controller comprising hardware, the controller being configured to access a data memory on which a function list is stored, in which the required operating pressure and the required volume flow are stored for the at least two different adjustment functions,
wherein, for a first adjustment function to be executed from the at least two adjustment functions, the controller is further configured to retrieve the operating pressure required for the first adjustment function and the volume flow required for the first adjustment function from the function list and to control the at least one hydraulic valve in order to transfer the at least one hydraulic valve into the first position, the second position, or the third position depending on the operating pressure required for the first adjustment function and the volume flow required for the first adjustment function.

6. The industrial truck according to claim 5, wherein the controller is configured to compare the operating pressure required for the first adjustment function to be executed with a limit pressure in order to select the position into which the at least one hydraulic valve is transferred.

7. The industrial truck according to claim 5, wherein the controller is configured to compare the volume flow required for the first adjustment function to be executed with a first limit volume flow and a second limit volume flow to select one of the first position, second position or third position into which the at least one hydraulic valve is transferred.

8. The industrial truck according to claim 7, wherein the controller is configured to have the at least one hydraulically operated component operated exclusively by the first hydraulic pump, provided that the required operating pressure is greater than the limit pressure and the required volume flow is less than the first limit volume flow.

9. The industrial truck according to claim 7, wherein the controller is configured to have the at least one hydraulically operated component operated exclusively by the second hydraulic pump if the required operating pressure is less than the limit pressure or the required volume flow is greater than the first limit volume flow and less than the second limit volume flow.

10. The industrial truck according to claim 7, wherein the controller is configured to have the at least one hydraulically operated component operated simultaneously by the first hydraulic pump and the second hydraulic pump, provided that the required volume flow is greater than the second limit volume flow.

11. The industrial truck according to claim 1, wherein
the at least one hydraulically operated component comprises at least one hydraulic lifting cylinder for one or more of raising and lowering a load fork of the industrial truck, and
the controller is configured to have the at least one lifting cylinder operated exclusively by the first hydraulic pump or exclusively by the second hydraulic pump or simultaneously by the first hydraulic pump and the second hydraulic pump, depending on a deflection speed of the lifting cylinder.

12. The industrial truck according to one of claim 1, wherein
the at least one hydraulically operated component comprises an auxiliary component, and
the controller is configured to have the auxiliary component operated exclusively by the second hydraulic pump.

13. The industrial truck according to claim 1, wherein the controller is configured to regulate an efficiency portion of one or more of the first hydraulic pump and the second hydraulic pump when the first hydraulic pump and the second hydraulic pump are operated simultaneously.

14. The industrial truck according to claim 13, wherein the efficiency portion is regulated by reducing one or more of a pump output and a flow rate.

15. A method for operating a hydraulic system of an industrial truck, wherein the hydraulic system comprises a first hydraulic pump, a second hydraulic pump and a hydraulic line system, the method comprising:
selectively connecting, using the hydraulic line system at least one hydraulically operated component either exclusively to the first hydraulic pump or exclusively to the second hydraulic pump or simultaneously to the first hydraulic pump and the second hydraulic pump,
wherein the first hydraulic pump has a first efficiency maximum at a first volume flow and a first operating pressure and the second hydraulic pump has a second efficiency maximum at a second volume flow and a second operating pressure, and
one or more of the first operating pressure is greater than the second operating pressure and the first volume flow is smaller than the second volume flow.

16. The method according to claim 15, wherein the hydraulic line system comprises at least one hydraulic valve, the method further comprising:
selectively setting the at least one hydraulic valve to a first position, a second position or a third position,
wherein in the first position the at least one hydraulically operated component is connected exclusively to the first hydraulic pump, in the second position the at least one hydraulically operated component is connected exclusively to the second hydraulic pump, and in the third position the at least one hydraulically operated component is connected simultaneously to the first hydraulic pump and the second hydraulic pump.

17. The method according to claim 15, wherein the at least one hydraulically operated component executes at least two different adjustment functions which differ with regard to one or more of a required volume flow and a required operating pressure.

18. The method according to claim 17, wherein a controller of the industrial truck accesses a data memory on which a function list is stored, in which the required operating pressure and the required volume flow are stored for the at least two different adjustment functions, wherein, for a first adjustment function to be executed from the at least two different adjustment functions, the controller retrieves the operating pressure required for the first adjustment function and the volume flow required for the first adjustment function from the function list and controls the at least one hydraulic valve to transfer the at least one hydraulic valve into the first position, the second position, or the third position depending on the operating pressure required for the first adjustment function and the volume flow required for the first adjustment function.

19. The method according to claim 15, wherein the controller regulates an efficiency portion of one or more of the first hydraulic pump and the second hydraulic pump when the first hydraulic pump and the second hydraulic pump are operated simultaneously.

20. The method according to claim 19, wherein the efficiency portion is regulated by reducing one or more of a pump output and a flow rate.
